(19) United States
(12) Patent Application Publication
(10) Pub. No.: US 2025/0325029 A1
(43) Pub. Date: Oct. 23, 2025

(54) CARTRIDGE COMPRISING AEROSOL-GENERATING BEADS

(71) Applicant: PHILIP MORRIS PRODUCTS S.A., Neuchatel (CH)

(72) Inventors: Gérard ZUBER, Boulens (CH); Özgür ÖZSUN, Kilchberg (CH); Amir FERIANI, Saint-Blaise (CH); Manuel THOMET, Liebefeld (CH); Eric MISSELWITZ, Fischbach-Göslikon (CH); Stefan BRÜNGGER, Bern (CH)

(21) Appl. No.: 18/871,180

(22) PCT Filed: Jun. 2, 2023
(86) PCT No.: PCT/EP2023/064830

§ 371 Date: Dec. 3, 2024

(30) Foreign Application Priority Data
Jun. 3, 2022 (EP) 22177271.8

(51) Int. Cl. A24F 40/42; A24F 40/20; A24F 40/60; H05B 6/10

(52) U.S. Cl. CPC A24F 40/42; A24F 40/20; A24F 40/60; H05B 6/108

(57) ABSTRACT

The invention relates to a cartridge for an aerosol-generating device and the respective aerosol-generating device. The cartridge comprises aerosol-generating beads comprising an aerosol-forming substrate and storage element configured to store the aerosol-generating beads. The storage element is configured to allow loading of the aerosol-generating beads from the storage element. The aerosol-generating device comprises a receiving region configured to receive the cartridge, the heating arrangement configured to heat the aerosol-generating beads, and a loading element configured to load the aerosol-generating beads from the cartridge into or adjacent to the heating arrangement and to remove used beads from the heating arrangement.

The present invention relates to a cartridge for an aerosol-generating device, to a cartridge and to a system.

It is known to provide an aerosol-generating device for generating an inhalable vapor. Such devices may heat aerosol-forming substrate to a temperature at which one or more components of the aerosol-forming substrate are volatilised without burning the aerosol-forming substrate. Aerosol-forming substrate may be provided as part of an aerosol-generating bead. The aerosol-generating bead may be supplied from a cartridge. The cartridge may contain many aerosol-generating beads.

It would be desirable to provide a cartridge, a device and an aerosol-generating system that enables a user to easily consume the beads. Furthermore, it would be desirable to provide a cartridge, a device and an aerosol-generating system that is reliable. Additionally, it would be desirable to provide a cartridge, a device and an aerosol-generating system that can easily handled by a user. It also may be advisable to provide a device, a cartridge and an aerosol-generating system including the device and the cartridge which would allow the user to easily consume a predetermined amount of the beads upon the user's convenience.

According to an embodiment of the invention there is provided a cartridge for an aerosol-generating device, the cartridge comprising aerosol-generating beads comprising an aerosol-forming substrate. The cartridge may comprise a storage element configured to store the aerosol-generating beads. The storage element may be configured to allow loading of the aerosol-generating beads from the storage element.

According to another embodiment of the invention there is provided a cartridge for an aerosol-generating device, wherein the cartridge comprises aerosol-generating beads comprising an aerosol-forming substrate. The cartridge furthermore comprises a storage element configured to store the aerosol-generating beads. The storage element is configured to allow loading of the aerosol-generating beads from the storage element.

Such a cartridge may allow the user to load a predetermined amount of the aerosol-generating beads from the storage element for consumption.

As used herein, the term ‘aerosol-forming substrate’ relates to a substrate capable of releasing volatile compounds that can form an aerosol. Such volatile compounds may be released by heating the aerosol-forming substrate.

The aerosol-forming substrate is a substrate capable of releasing volatile compounds that can form an aerosol. The volatile compounds may be released by heating the aerosol-forming substrate. The aerosol-forming substrate may comprise nicotine. The aerosol-forming substrate may comprise plant-based material. The aerosol-forming substrate may comprise tobacco. The aerosol-forming substrate may comprise a tobacco-containing material containing volatile tobacco flavour compounds, which are released from the aerosol-forming substrate upon heating. The aerosol-forming substrate may alternatively comprise a non-tobacco-containing material. The aerosol-forming substrate may comprise homogenised plant-based material, including homogenized tobacco, for example made by, for example, a paper making process or a casting process.

The aerosol-forming substrate may comprise at least one aerosol-former. An aerosol-former is any suitable known compound or mixture of compounds that, in use, facilitates formation of a dense and stable aerosol and that is substantially resistant to thermal degradation at the temperature of operation of the system. Suitable aerosol-formers are for example: polyhydric alcohols, such as triethylene glycol, 1,3-butanediol and glycerine; esters of polyhydric alcohols, such as glycerol mono-, di- or triacetate; and aliphatic esters of mono-, di- or polycarboxylic acids, such as dimethyl dodecanedioate and dimethyl tetradecanedioate. Aerosol formers may be polyhydric alcohols or mixtures thereof, such as triethylene glycol, 1,3-butanediol and glycerine. The aerosol-former may be propylene glycol. The aerosol former may comprise both glycerine and propylene glycol. The aerosol former may comprise one or more of glycerine and propylene glycol. The aerosol former may consist of glycerine or propylene glycol or of a combination of glycerine and propylene glycol. Preferred examples of suitable aerosol formers are glycerine and propylene glycol.

Preferably, the amount of aerosol former is between 6 percent and 20 percent by weight on a dry weight basis of the aerosol-forming substrate, more preferably, the amount of aerosol former is between 8 percent and 18 percent by weight on a dry weight basis of the aerosol-forming substrate, most preferably the amount of aerosol former is between 10 percent and 15 percent by weight on a dry weight basis of the aerosol-forming substrate. For some embodiments the amount of aerosol former has a target value of about 13 percent by weight on a dry weight basis of the aerosol-forming substrate. The most efficient amount of aerosol former will depend also on the aerosol-forming substrate, whether the aerosol-forming substrate comprises plant lamina or homogenized plant material. For example, among other factors, the type of substrate will determine to which extent the aerosol-former can facilitate the release of substances from the aerosol-forming substrate.

Preferably, the aerosol-forming substrate comprises cut-filler. In this document, “cut-filler” is used to refer to a blend of shredded plant material, in particular leaf lamina, processed stems and ribs, homogenized plant material, like for example made into sheet form using casting or papermaking processes. The cut filler may also comprise other after-cut, filler tobacco or casing. According to preferred embodiments of the invention, the cut-filler comprises at least 25 percent of plant leaf lamina, more preferably, at least 50 percent of plant leaf lamina, still more preferably at least 75 percent of plant leaf lamina and most preferably at least 90 percent of plant leaf lamina. Preferably, the plant material is one of tobacco, mint, tea and cloves, however, the invention is equally applicable to other plant material that has the ability to release substances upon the application of heat that can subsequently form an aerosol.

Preferably, the tobacco plant material comprises lamina of one or more of bright tobacco lamina, dark tobacco, aromatic tobacco and filler tobacco. Bright tobaccos are tobaccos with a generally large, light coloured leaves. Throughout the specification, the term “bright tobacco” is used for tobaccos that have been flue cured. Examples for bright tobaccos are Chinese Flue-Cured, Flue-Cured Brazil, US Flue-Cured such as Virginia tobacco, Indian Flue-Cured, Flue-Cured from Tanzania or other African Flue Cured. Bright tobacco is characterized by a high sugar to nitrogen ratio. From a sensorial perspective, bright tobacco is a tobacco type which, after curing, is associated with a spicy and lively sensation. According to the invention, bright tobaccos are tobaccos with a content of reducing sugars of between about 2.5 percent and about 20 percent of dry weight base of the leaf and a total ammonia content of less than about 0.12 percent of dry weight base of the leaf. Reducing sugars comprise for example glucose or fructose. Total ammonia comprises for example ammonia and ammonia salts. Dark tobaccos are tobaccos with a generally large, dark coloured leaves. Throughout the specification, the term “dark tobacco” is used for tobaccos that have been air cured. Additionally, dark tobaccos may be fermented. Tobaccos that are used mainly for chewing, snuff, cigar, and pipe blends are also included in this category. Typically, these dark tobaccos are air cured and possibly fermented. From a sensorial perspective, dark tobacco is a tobacco type which, after curing, is associated with a smoky, dark cigar type sensation. Dark tobacco is characterized by a low sugar to nitrogen ratio. Examples for dark tobacco are Burley Malawi or other African Burley, Dark Cured Brazil Galpao, Sun Cured or Air Cured Indonesian Kasturi. According to the invention, dark tobaccos are tobaccos with a content of reducing sugars of less than about 5 percent of dry weight base of the leaf and a total ammonia content of up to about 0.5 percent of dry weight base of the leaf. Aromatic tobaccos are tobaccos that often have small, light coloured leaves. Throughout the specification, the term “aromatic tobacco” is used for other tobaccos that have a high aromatic content, e.g. of essential oils. From a sensorial perspective, aromatic tobacco is a tobacco type which, after curing, is associated with spicy and aromatic sensation. Example for aromatic tobaccos are Greek Oriental, Oriental Turkey, semi-oriental tobacco but also Fire Cured, US Burley, such as Perique, Rustica, US Burley or Meriland. Filler tobacco is not a specific tobacco type, but it includes tobacco types which are mostly used to complement the other tobacco types used in the blend and do not bring a specific characteristic aroma direction to the final product. Examples for filler tobaccos are stems, midrib or stalks of other tobacco types. A specific example may be flue cured stems of Flue Cure Brazil lower stalk.

The cut-filler suitable to be used with the present invention generally may resemble to cut-filler used for conventional smoking articles. The cut width of the cut filler preferably is between 0.3 millimeters and 2.0 millimeters, more preferably, the cut width of the cut filler is between 0.5 millimeters and 1.2 millimeters and most preferably, the cut width of the cut filler is between 0.6 millimeters and 0.9 millimeters. The cut width may play a role in the distribution of heat inside the substrate portion of the article. Also, the cut width may play a role in the resistance to draw of the article. Further, the cut width may impact the overall density of the substrate portion.

The strand length of the cut-filler is to some extent a random value as the length of the strands will depend on the overall size of the object that the strand is cut off from. Nevertheless, by conditioning the material before cutting, for example by controlling the moisture content and the overall subtlety of the material, longer strands can be cut. Preferably, the strands have a length of between about 10 millimeters and about 40 millimeters before the strands are formed into the substrate section.

As used herein, the term ‘aerosol-generating beads’ relates to a discrete aerosol-forming substrate. The aerosol-generating beads may be solid. The aerosol-generating beads may comprise tobacco, for example homogenised tobacco. The aerosol-generating beads may comprise an aerosol-former.

The storage element may be configured to allow loading of one single bead from the storage element at a time. This may allow a user to load one single bead from the storage element with one loading step. One single bead therefore may provide one user experience of inhaling the aerosol. This may allow a user to easily determine the amount of the beads to be consumed upon the user's convenience.

The storage element of the cartridge may furthermore comprise a support element, wherein the support element comprises through holes. The through holes may be configured to accommodate the beads. The cartridge therefore may contain a predetermined amount of the beads in the through holes. This may allow a user to load a predetermined amount of the beads from the storage element of the cartridge.

Preferably, one through hole of the support element of the cartridge may be configured to accommodate one bead. This may allow a user to specifically load one bead from one through hole of the cartridge.

The support element may comprise a disk. The through holes may be arranged around the peripheral circumference of the disc.

This may allow an easy arrangement of the through holes and therefore the beads on the support element.

The through holes may include retention elements. The retention elements may be configured to removably hold the beads in the through holes.

This may allow an easy removal of the beads from the through holes due to the retention elements.

The retention elements may be arranged around the circumference of the through holes. This may allow the retention elements to easily hold the beads within the through holes.

The retention elements may comprise flexible protrusions holding the beads in the through holes. The retention elements for example may comprise flexible plastic or elastomers. Preferably, the retention elements may comprise a ring of flexible plastic protrusions or a ring of a flexible elastomer around the circumference of the through holes.

The support element may comprise a first major surface and a second opposing major surface. The through holes may connect the first major surface and the second major surface. The retention elements may be arranged around the through holes on one or both of the first major surface and the second major surface. This may allow an easy retention of the beads within the through holes.

The cartridge may be configured to be detachably rotatably connectable to an aerosol-generating device. The cartridge for example may comprise a central hole in the support element. This may allow an axis or a rod to be inserted into the cartridge in order to detachably rotatably connect the cartridge to an aerosol-generating device.

Alternatively, the support element of the cartridge may comprise a circular shape, such as a disc. Such a support element may be configured to be rotatably mounted in an aerosol-generating device. Rotation of the support element of the cartridge may provide an easy way in order to access and load the beads accommodated in different through holes of the support element.

In another embodiment of the cartridge the cartridge may further comprise a connection element, wherein the connection element may be configured to be detachably connectable to an aerosol-generating device. The storage element may be configured to allow loading of the aerosol-generating beads into the connection element.

Such a connection element may be an alternative way to detachably connect the cartridge to an aerosol-generating device. The connection element may comprise a hollow structure. The hollow structure may be a circular structure. The hollow structure may be configured to accommodate a rotatable conveyor of the aerosol-generating device as will be described in greater detail further below.

The cartridge may furthermore comprise a loading element. The loading element may be configured for loading the beads from the storage element to the connection element. The loading element may ease the loading of the beads from the storage element to the connection element.

The loading element may be incrementally movable connected with the storage element. A single incremental movement may be configured to load one bead into the connection element.

The loading element may be configured to be translationally movable relative to the storage portion. The translational movement may allow loading of the beads from the storage element into the connection element.

The storage element may be configured to store the aerosol-generating beads in a row. the storage element may be configured to store individual aerosol-generating beads one after the other. The loading element may comprise protrusions extending into the storage element. The protrusions may separate individual aerosol-generating beads from each other.

Such a loading element may be able to load one single bead from the storage element into the connection element via a translational movement of the loading element relative to the storage element.

The loading element may be an elongate element. Such an elongate element may be movably mounted in a rail of the storage element. This may ease translational movement of the loading element relative to the storage element.

Preferably the loading element may comprise or consist of a bar.

The loading element may comprise a second engagement element. The second engagement element may be configured to be engaged with a second activation element of the aerosol-generating device. Preferably, the second engagement element may comprise saw teeth. The loading element may comprise a bar including saw teeth.

The loading element including a second engagement element may easily actuated by a user by triggering the second activation element. This may allow a user to load one aerosol-generating bead from the storage element into the connection element.

The cartridge may furthermore comprise a waste storage element. The waste storage element may be configured to store used aerosol-generating beads after consumption by the user. Preferably, the waste storage element may be connected to the connection element. The waste storage element may be connected to the connection element at the opposite side of the storage element. This may provide an easy connection between the storage element storing fresh beads for use and the waste storage element storing used beads.

According to another embodiment of the cartridges of the present invention the cartridge may comprise a dispenser. The dispenser may be configured for loading the aerosol-generating beads from the storage element. Preferably the dispenser may be connected to a push button. This may allow a user to easily trigger the dispenser by pushing the push button.

The dispenser may comprise an outlet with a movable cover. The movable cover may be configured to be opened upon a user pressing the push button. The dispenser also may comprise a rotatable collector. The rotatable collector may include recesses for conveying the beads from the cartridge to the aerosol-generating device.

Another embodiment of the invention is directed to an aerosol-generating device. The aerosol-generating device may comprise a receiving region configured to receive a cartridge as described herein. Furthermore, the aerosol-generating device may comprise a heating arrangement configured to heat the aerosol-generating beads. The aerosol-generating device may also comprise a loading element. The loading element may be configured to load the aerosol-generating beads from the cartridge into or adjacent to the heating arrangement.

A further embodiment of the invention is directed to an aerosol-generating device which comprises a receiving region configured to receive a cartridge as described herein. The aerosol-generating device comprises a heating arrangement configured to heat the aerosol-generating beads. The aerosol-generating device also comprises a loading element. The loading element may be configured to load the aerosol-generating beads from the cartridge into or adjacent to the heating arrangement.

The loading element may be configured to load one single bead from the cartridge at a time. This may allow the loading element to load a single aerosol-generating beads from the storage element of the cartridge. in particular, the loading element may be configured to load one single aerosol-generating bead from the cartridge with one loading step.

The receiving region may be configured to receive a cartridge as described herein. In particular the receiving region may be configured to receive a cartridge wherein the storage element comprises the support element as described herein. The aerosol-generating device may furthermore comprise a pushing element. The pushing element may be configured for pushing beads accommodated in the through holes of the supporting element into the heating arrangement. Preferably, the pushing element may also be configured for pushing beads out of the heating arrangement. The pushing element also may be configured for pushing beads out of the heating arrangement back into the through holes of the cartridge. In particular, the pushing element may be configured to push used beads out of the heating arrangement back into their respective through holes in the cartridge.

Such a pushing element may allow a user to select beads or one single bead accommodated in a through hole for being inserted into the heating arrangement and for being removed from the heating arrangement after use.

The pushing element may comprise two opposing first and second pistons. The first and second pistons may be configured to simultaneously move forward and backward relative to the through holes of the cartridge. This may allow the pushing element to push the aerosol-generating beads out of the through holes into the heating arrangement using one piston, preferably the first piston. This pushing element may also be configured to push a used aerosol-generating bead out of the heating arrangement back into its through hole in the cartridge employing the second piston.

The receiving region may be configured to rotatably movably receive the cartridge. This may allow cartridge to be connected to the aerosol-generating device so that the cartridge can be rotated within the device. Preferably, the receiving region may comprise a slot. This may enable the receiving region of the cartridge to be received in such a way that it can easily be rotated within the device.

The slot also may include wheels. The wheels may allow a cartridge to be received in the slot to be rotatable.

The aerosol-generating device may furthermore comprise a first activation element. The first activation element may be configured to activate the pushing element. This may allow a user to handle the aerosol-generating device via the first activation element.

Preferably the pushing element may comprise shank. The first activation element may comprise a guiding groove for activating the pushing element. The guiding groove may slidably receive the shank of the pushing element. This may allow the first activation element to activate the pushing element via the guiding groove.

The first activation element may also be configured to subject the cartridge to a movement. Preferably the movement may be a rotational movement. In particular, the rotational movement may be an incremental rotational movement between adjacent through holes of the cartridge. This may allow the first activation element of the aerosol-generating device to control the rotation of the cartridge. This may enable the use of the various aerosol-forming beads accommodated in the through holes of the cartridge.

In particular, the first activation element may be configured to subject the cartridge to an incremental rotational movement so that successive through holes of the cartridge are accessible to the pushing element of the aerosol-generating device.

The first activation element of the aerosol-generating device may comprise a first engaging arm. The first engaging arm may be configured to subject the cartridge to a movement. Preferably the first engaging arm may subject the cartridge to a rotational movement. The first engaging arm may comprise a groove. The groove may be configured for engaging with the support element of the cartridge. the first engaging arm may comprise two opposing plates. The groove for engaging with the support element of the cartridge may be located between the opposing plates. The opposing plates furthermore may be configured to engage with the retention elements located near or around the through holes. This may allow the first activation element to control the movement, in particular the rotational movement of the cartridge via the first engaging arm.

The first activation element of the aerosol-generating device may comprise a push button for a user to cause a translational forward movement of the first activation element. This may allow a user to handle the aerosol-generating device via pressing the push button. The translational forward movement of the first activation element may actuate the pushing element and may subject the cartridge to the rotational movement already mentioned. This may enable a user to control both the rotation of the cartridge and the change of the aerosol-forming beads in the cartridge via pressing the push bottom of the first activation element.

The first activation element may comprise a first flexible biasing member. The first flexible biasing member may comprise or consist of a spring. the first flexible biasing member may be compressed by the first activation element to the translational forward movement. This may allow the first activation element to carry out a translational backward movement owing to the action of the compressed first flexible biasing member.

In particular, the translational forward movement of the first activation element may compress the first flexible biasing member. The first flexible compressed biasing member may be configured to cause a translational backward movement of the first activation element. The translational backward movement of the first activation element may be in the opposite direction of the translational forward movement.

Both the translational forward movement of the first activation element and the translational backward movement of the first activation element may compete one cycle of the aerosol-generating device. One complete cycle may include removal of a used aerosol-forming bead from the heating arrangement and the insertion of a new aerosol-forming bead in the heating arrangement.

The translational forward movement and the translational backward movement of the first activation element may cause one or more of:
pushing of used beads out of the heating arrangement,
pushing of beads from the cartridge into the heating arrangement, and
rotational movement of the cartridge.

Preferably, the translational forward movement and the translational backward movement of the first activation element may cause all three above mentioned process steps. This may complete one cycle of usage for a user including removing the used beads out of the heating arrangement, rotation of the cartridge in order to align a new bead with the pushing element and pushing of this new bead into the heating arrangement.

The cartridge may be rotated from one through hole to the next successive through hole in order to use all the beads positioned in the through holes.

Another embodiment of the aerosol-generating device of the present invention may comprise a receiving region including a rotatably mounted conveyor. The conveyor may be configured to be connectable to a connection region of the cartridge as already described therein. In particular, the rotatably mounted conveyor of this aerosol-generating device may be rotatably accommodated within the connection region of the cartridge.

The rotatably mountable conveyor of the aerosol-generating device may comprise a circular circumference. Similar, the connection region of the cartridge may comprise a hollow circular body which may be configured to receive conveyor.

The rotatable conveyor may be configured to convey the beads from the connection element to the heating arrangement. In particular, the rotatable conveyor may be configured to convey the beads from the connection element adjacent to the heating arrangement within the rotatable conveyor. The beads in this position may be located on a metallic support, for example a metallic clip. The beads may be heated in such a position via thermal convection from the heating arrangement to the metallic support. The hot metallic support may heat the bead without the bead being located in the heating arrangement. This may enable the rotatable conveyor to further convey the used bead away from the heating arrangement.

Preferably, the rotatable conveyor is configured to convey one single bead from the connection element to the heating arrangement via one rotational movement. This may enable a user to enjoy one bead employing one rotational movement of the rotatable conveyor.

The rotatable conveyor may furthermore be configured to convey the beads from the heating arrangement to the waste storage element. In particular, the rotatable conveyor may be configured to convey one single bead from the heating arrangement to the waste storage element via one rotational movement. This may be a particular easy way in order to convey used beads away from the heating arrangement.

The rotatable conveyor may comprise recesses for conveying the beads. Preferably, one recess may be configured for conveying one bead at a time.

In particular, the rotatable conveyor may comprise more than one recess. Preferably, the rotatable conveyor may comprise four recesses for conveying beads between different positions within the aerosol-generating system.

The rotatable conveyor may be incrementally rotatable between the first position at the connection element and a second position at the heating arrangement. In the first position the recess of the rotatable conveyor may be ready to accept one bead from the storage element of the cartridge. In the second position, the rotatable conveyor may place the bead near or adjacent to the heating arrangement for being heated. The rotatable conveyor may rotate between these different positions via 90 degree rotations.

Furthermore, the rotatable conveyor may be incrementally rotatable between the second position at the heating arrangement and a third position at the waste storage element. Such an aerosol-generating device therefore may be configured to convey a bead from the first position to the second position and then to the third position into the waste storage element of the cartridge.

The aerosol-generating device according to this embodiment may comprise a second actuation element. The second actuation element may be configured to actuate the rotatably mounted conveyor. Such a second actuation element may enable a user to easily handle the aerosol-generating device via the actuation element.

The second actuation element may comprise a second engaging arm. The second engaging arm may be configured to actuate the rotatably mounted conveyor. The second engaging arm may engage with a conveyor engaging element of the rotatable conveyor. The conveyor engaging element may be a gear wheel. The real may include indentations which are configured for engaging with the second engaging arm.

The second engaging arm may be connected to the second actuation element via a second engaging arm biasing element, for example a spring. This may allow the second engaging arm to be flexibly connected to the second actuation element.

The second actuation element may also be configured to actuate the loading element of the cartridge. The second actuation element may comprise a rod. The rod may be configured to engage with the already mentioned engagement element of the loading element.

The second engagement element may comprise a push button for a user to cause a translational forward movement of the second actuation element. The translational forward movement of the second actuation element may actuate the rotatable conveyor. The translational forward movement of the second actuation element may actuate an incremental rotational movement of the rotatable conveyor.

The second actuation element may comprise a second flexible biasing member, for example a spring. The translational forward movement of the second actuation element may compress the second flexible biasing member. The compressed second flexible biasing member may be configured to cause a translational backward movement of the second actuation element. In particular, the translational backward movement may move the second actuation element to a starting position of the actuation element. This starting position may be the same position as the position taken by the second actuation element before a user triggers the push button of the actuation element.

The translational forward movement and the translational backward movement of the second actuation element may cause one or more of:
conveying a bead to or adjacent to the heating arrangement via a movement of the rotatable conveyor,
conveying a bead to the waste storage element via a movement of the rotatable conveyor, and
actuating the loading element for loading a bead from the storage element into the rotatable conveyor.

In particular, the translational forward movement may trigger the rotatable conveyor to convey a bead either to or adjacent to the heating arrangement or to the waste storage element. The translational backward movement may trigger the loading element to load a bead from the storage element into the rotatable conveyor.

In another embodiment of an aerosol-generating device of the present invention, the device comprises a receiving region which is configured to receive a cartridge which includes a dispenser as already described herein.

The heating arrangement of the aerosol-generating device may comprise a converging conduct. The converging conduct may be configured to receive a bead from the cartridge via the dispenser. The converging conduct may comprise a heater. The converging conduct may comprise two opposing plates wherein a distance of the two opposing plates narrows with increasing distance of the converging conduct from the cartridge. The heater may be located in an area of minimal distance between the two opposing plates. This may provide an easy measure for receiving and holding a bead near the heater in order to form an aerosol by heating the bead.

After heating the bead, at least a part of the opposing plates may be retracted in order to release the used bead. This may enable a used bead to fall into the waste storage element of the aerosol-generating device. Otherwise, a diameter of the bead may shrink while it is heated. In this case the bead may fall into a waste storage element of the aerosol-generating device once the diameter of the bead is smaller than the minimum distance between the two opposing plates. This may provide an easy way of discarding used beads. The bead may shrink owing to the evaporation of the flavour compounds and the aerosol-former.

The heating arrangement may comprise one or both of an inductive heating arrangement and a resistive heating element. A resistive heating arrangement may comprise a heating coil disposed around the first part of the compartment wall of the aerosol-generating device. The resistive heating arrangement may comprise a resistive wire. The resistive wire may be wrapped around the first part of the compartment wall of the aerosol-generating device.

Suitable electrically resistive materials for the resistive include but are not limited to: semiconductors such as doped ceramics, electrically “conductive” ceramics (such as, for example, molybdenum disilicide), carbon, graphite, metals, metal alloys and composite materials made of a ceramic material and a metallic material. Such composite materials may comprise doped or undoped ceramics. Examples of suitable doped ceramics include doped silicon carbides. Examples of suitable metals include titanium, zirconium, tantalum and metals from the platinum group. Examples of suitable metal alloys include stainless steel, nickel-, cobalt-, chromium-, aluminium-titanium-zirconium-, hafnium-, niobium-, molybdenum-, tantalum-, tungsten-, tin-, gallium-, manganese- and iron-containing alloys, and super-alloys based on nickel, iron, cobalt, stainless steel, Timetal® and iron-manganese-aluminium based alloys. In composite materials, the electrically resistive material may optionally be embedded in, encapsulated or coated with an insulating material or vice-versa, depending on the kinetics of energy transfer and the external physicochemical properties required. Examples of suitable composite heater elements are disclosed in U.S. Pat. No. 5,498,855, WO-A-03/095688 and U.S. Pat. No. 5,514,630. One preferred resistive heating material may be nickel chromium alloy.

Preferably, the heating arrangement may be an inductive heating element. The heating arrangement may preferably be an induction coil. The compartment wall may be a susceptor. The inductive heating element, preferably the induction coil may be configured for heating the first part of the compartment wall. The inductive heating arrangement may be connected to a power supply. The inductor coil may be able to provide an inductance of between 1 micro Henry (μH) to 500 nano Henry (nH).

The different elements of the cartridges and aerosol-generating devices described herein can be made of a large variety of different materials. The materials include one or more of: plastic, metal, wood.

In a further embodiment of the present invention an aerosol-generating system is provided. The aerosol-generating system comprises the cartridges as described herein and the aerosol-generating devices having the receiving sections for the particular cartridges.

In particular, a cartridge wherein the storage element comprises the support element as described herein may be used in conjunction with a device including a pushing element configured for pushing beads located in the through holes of the support element into the heating arrangement. In the following a cartridge including the support element and a device including a receiving section for such a cartridge will be referred to as embodiment 1.

Furthermore, a cartridge comprising a connection element as described herein may be used in conjunction with an aerosol-generating device whose receiving region comprises a rotatably mounted conveyor. The connection element may comprise a hollow circular structure or body. The hollow circular body may be configured to accommodate the rotatably mounted conveyor once the cartridge is detachably connected to the aerosol-generating device. in the following a cartridge comprising a connection element and the respective aerosol-generating device to be connected to such a cartridge will be referred to as embodiment 2.

In another embodiment of the invention a cartridge comprises a dispenser as described herein. This cartridge can be connected to an aerosol-generating device including a converging conduct or movable, retractable plates as described herein. such a cartridge and the respective aerosol-generating devices will be referred to as embodiment 3.

All the cartridges described herein can be configured to be detachably connectable to their respective aerosol-generating devices. This may allow a user to simply discard the cartridge once all the beads have been used and to re-use the aerosol-generating devices.

Below, there is provided a non-exhaustive list of non-limiting examples. Any one or more of the features of these examples may be combined with any one or more features of another example, embodiment, or aspect described herein.

Example A: A cartridge for an aerosol-generating device, the cartridge comprising:
aerosol-generating beads comprising an aerosol-forming substrate,
a storage element configured to store the aerosol-generating beads,
wherein the storage element is configured to allow loading of the aerosol-generating beads from the storage element.

Example B: The cartridge according to example A, wherein the storage element is configured to allow loading of one single bead from the storage element by one loading step.

Example C: The cartridge according to any of the preceding examples, wherein the storage element comprises a support element, the support element comprising through holes, wherein the through holes are configured to accommodate the beads, preferably wherein one through hole is configured to accommodate one bead.

Example D: The cartridge according to the preceding example, wherein the support element comprises a disk and wherein the through holes are arranged around its peripheral circumference.

Example E: The cartridge according to any of the preceding examples C or D, wherein the through holes include retention elements which are configured to removably hold the beads in the through holes, preferably wherein the retention elements are arranged around a circumference of the through holes, more preferably wherein the retention elements comprise flexible protrusions holding the beads in the through holes.

Example F: The cartridge according to any of the preceding examples C to E, wherein the support element comprises a first major surface and a second opposing major surface, wherein the through holes connect the first major surface and the second major surface, preferably wherein the retention elements are arranged around the through holes on one or both: the first major surface and the second major surface.

Example G: The cartridge according to any of the preceding examples C to F, wherein the cartridge is configured to be detachably rotatably connectable to an aerosol-generating device.

Example H: The cartridge according to any of the preceding examples A or B, further comprising a connection element, the connection element being configured to be detachably connectable to an aerosol-generating device, wherein the storage element is configured to allow loading of the aerosol-generating beads into the connection element.

Example I: The cartridge according to the preceding example, further comprising a loading element configured for loading the beads from the storage element to the connection element, wherein the loading element is movably connected with the storage element.

Example J: The cartridge according to the preceding example, wherein the loading element is incrementally movably connected with the storage element and wherein a single incremental movement is configured to load one bead into the connection element.

Example K: The cartridge according to the preceding example, wherein the loading element is configured to be translationally movable relative to the storage portion, and wherein the translational movement allows loading of the beads from the storage element into the connection element.

Example L: The cartridge according to any of the preceding examples I to K, wherein the storage element is configured to store the aerosol-generating beads in a row and wherein the loading element comprises protrusions extending into the storage element, wherein the protrusions separate individual beads from each other.

Example M: The cartridge according to any of the preceding examples I to L, wherein the loading element is an elongate element which is movably mounted in a rail of the storage element, preferably wherein the loading element comprises or consists of a bar.

Example N: The cartridge according to any of the preceding examples I to M, wherein the loading element comprises a second engagement element, wherein the second engagement element is configured to be engaged with a second actuation element of the aerosol-generating device, preferably wherein the second engagement element comprises saw teeth.

Example O: The cartridge according to any of the preceding examples H to N, further comprising a waste storage element configured to store used aerosol-generating beads, preferably wherein the waste storage element is connected to the connection element, more preferably wherein waste storage element is connected to the connection element at the opposite side of the storage element.

Example P: The cartridge according to any of the preceding examples A or B, further comprising a dispenser configured for loading of the aerosol-generating beads from the storage element, preferably wherein the dispenser is connected to a push button.

Example Q: An aerosol-generating device comprising:
a receiving region configured to receive a cartridge according to any of the preceding examples,
a heating arrangement configured to heat the aerosol-generating beads,
a loading element configured to load the aerosol-generating beads from the cartridge into or adjacent to the heating arrangement.

Example R: The aerosol-generating device according to the preceding example, wherein the loading element is configured to load one single bead from the cartridge at a time.

Example S: The aerosol-generating device according to any of the preceding examples Q or R, wherein the receiving region is configured to receive a cartridge according to any of the examples C to G, further comprising a pushing element configured for pushing beads accommodated in the through holes into the heating arrangement, preferably wherein the pushing element is further configured to push used beads out of the heating arrangement.

Example T: The aerosol-generating device according to the preceding example, wherein the pushing element comprises two opposing first and second pistons, wherein the first and second pistons are configured to simultaneously move forward and backward relative to the through holes of the cartridge.

Example U: The aerosol-generating device according to any of the preceding examples S or T, wherein the receiving region is configured to rotatably movably receive the cartridge, preferably wherein the receiving region comprises a slot.

Example V: The aerosol-generating device according to any of the preceding examples S to U, furthermore comprising a first actuation element, wherein the first actuation element is configured to actuate the pushing element, preferably wherein the pushing element comprises a shank and wherein the first actuation element comprises a guiding groove for actuating the pushing element.

Example W: The aerosol-generating device according to the preceding example, wherein the first actuation element is also configured to subject the cartridge to a movement, preferably wherein the movement is a rotational movement, more preferably wherein the rotational movement is an incremental rotational movement between adjacent through holes of the cartridge.

Example X: The aerosol-generating device according to the preceding example, wherein the first actuation element comprises a first engaging arm, wherein the first engaging arm is configured to subject the cartridge to a movement, preferably a rotational movement, more preferably wherein the first engaging arm comprises a groove configured for engaging with the support element of the cartridge.

Example Y: The aerosol-generating device according to any of the preceding examples V to X, wherein the first actuation element comprises a push button for a user to cause a translational forward movement of the first actuation element and wherein the translational forward movement actuates the pushing element and subjects the cartridge to the rotational movement.

Example Z: The aerosol-generating device according to any of the preceding examples V to Y, wherein the first actuation element comprises a first flexible biasing member, preferably a spring.

Example AA: The aerosol-generating device according to the preceding example, further dependent on example Y, wherein the translational forward movement of the first actuation element compresses the first flexible biasing member, and wherein the first flexible compressed biasing member is configured to cause a translational backward movement of the first actuation element.

Example AB: The aerosol-generating device according to the preceding claim, wherein the translational forward movement and the translational backward movement of the first actuation element causes one or more of:
pushing of used beads out of the heating arrangement,
pushing of beads from the cartridge into the heating arrangement, and
rotational movement of the cartridge.

Example AC: The aerosol-generating device according to any of the preceding examples Q or R, wherein the receiving region comprises a rotatably mounted conveyor, wherein the conveyor is configured to be connectable to the connection region of the cartridge according to any of the examples H to O.

Example AD: The aerosol-generating device according to the preceding example, wherein the rotatable conveyor is configured to convey the beads from the connection element to the heating arrangement, preferably wherein the rotatable conveyor is configured to convey one single bead from the connection element to the heating arrangement via one rotational movement.

Example AE: The aerosol-generating device according to the preceding example, further dependent on example O, wherein the rotatable conveyor is configured to convey the beads from the heating arrangement to the waste storage element, preferably wherein the rotatable conveyor is configured to convey one single bead from the heating arrangement to the waste storage element via one rotational movement.

Example AF: The aerosol-generating device according to any of the preceding examples AC to AE, wherein the conveyor comprises recesses for conveying the beads, preferably wherein one recess is configured to convey one bead.

Example AG: The aerosol-generating device according to the preceding example, wherein a recess of the rotatable conveyor is incrementally rotatable between a first position at the connection element and a second position at the heating arrangement, preferably wherein a recess of the rotatable conveyor is incrementally rotatable between the second position at the heating arrangement and a third position at the waste storage element.

Example AH: The aerosol-generating device according to any of the preceding examples AC to AG, furthermore comprising a second actuation element wherein the second actuation element is configured to actuate the rotatably mounted conveyor.

Example AI: The aerosol-generating device according to the preceding example, wherein the second actuation element comprises a second engaging arm, wherein the second engaging arm is configured to actuate the rotatably mounted conveyor.

Example AJ: The aerosol-generating device according to any of the preceding examples AH or AI, further dependent on any of the examples I to N, wherein the second actuation element is configured to actuate the loading element of the cartridge, preferably wherein the second actuation element comprises a rod which is configured to engage with the engagement element of the loading element.

Example AK: The aerosol-generating device according to any of the preceding examples AH to AJ, wherein the second actuation element comprises a push button for a user to cause a translational forward movement of the second actuation element and wherein the translational forward movement actuates the rotatable conveyor.

Example AL: The aerosol-generating device according to any of the preceding examples AH to AK wherein the second actuation element comprises a second flexible biasing member, preferably a spring.

Example AM: The aerosol-generating device according to the preceding example, further dependent on example AK, wherein the translational forward movement of the second actuation element compresses the second flexible biasing member, and wherein the second flexible compressed biasing member is configured to cause a translational backward movement of the second actuation element.

Example AN: The aerosol-generating device according to the preceding example, wherein the translational forward movement and the translational backward movement of the second actuation element causes one or more of:
conveying of a bead to or adjacent to the heating arrangement via a movement of the rotatable conveyor,
conveying of a bead to the waste storage element via a movement of the rotatable conveyor, and
actuating the loading element for loading a bead from the storage element into the rotatable conveyor.

Example AO: The aerosol-generating device according to any of the preceding examples Q or R, wherein the receiving region is configured to receive a cartridge according to example P, wherein the heating arrangement comprises a converging conduct, wherein the converging conduct is configured to receive a bead from the cartridge and wherein the converging conduct comprises a heater.

Example AP: The aerosol-generating device according to the preceding example, wherein the converging conduct comprises two opposing major surfaces and wherein a minimum distance between the opposing major surfaces is smaller than a diameter of one bead.

Example AQ: The aerosol-generating device according to the preceding example, wherein the heater is located in an area of the minimum distance between the opposing major surfaces.

Example AR: An aerosol-generating system comprising a cartridge according to any of the examples A to G and an aerosol-generating device according to any of the examples Q to AB.

Example AS: An aerosol-generating system comprising a cartridge according to any of the examples H to O and an aerosol-generating device according to any of the examples AC to AN.

Example AT: An aerosol-generating system comprising a cartridge according to example P and an aerosol-generating device according to any of the examples AO to AQ.

Features described in relation to one embodiment may equally be applied to other embodiments of the invention.

The invention will be further described, by way of example only, with reference to the accompanying drawings in which:

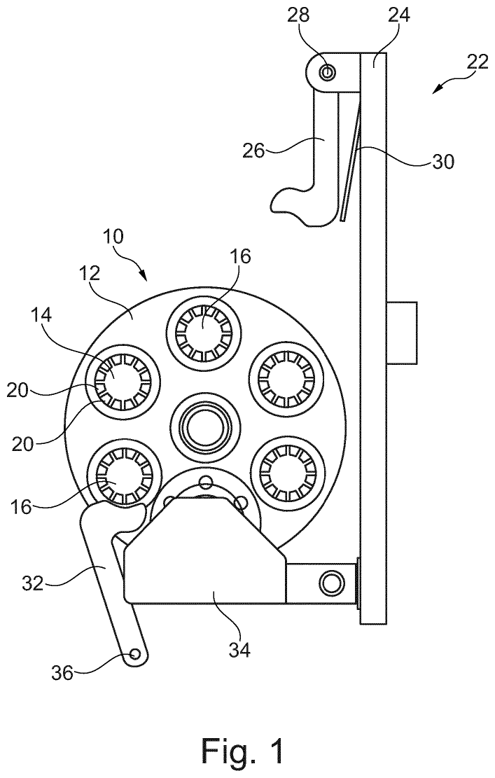

FIG. 1 shows a schematic side view of an aerosol-generating system according to embodiment 1;

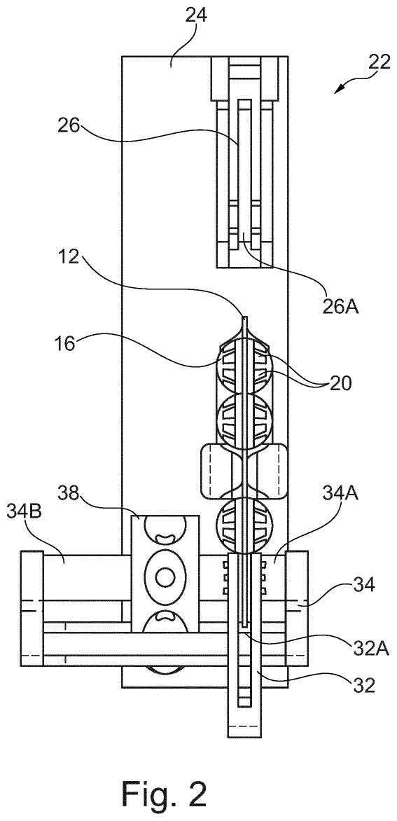

FIG. 2 depicts a side-view of the aerosol-generating system according to embodiment 1 shown in FIG. 1;

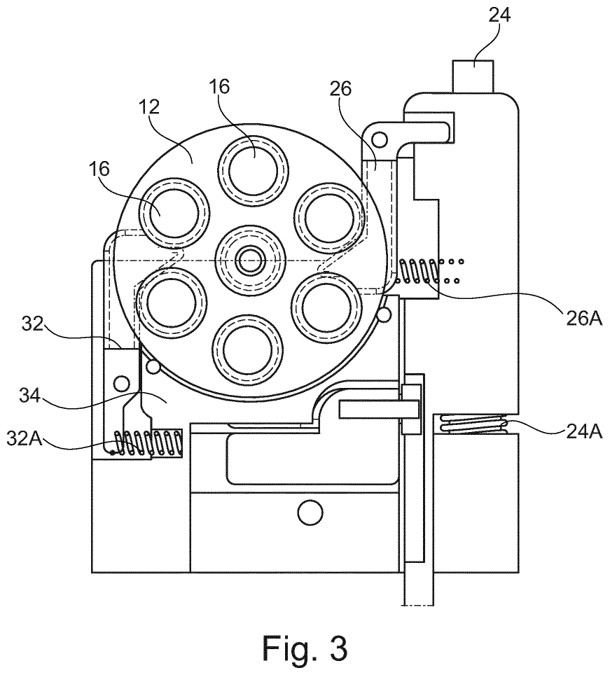

FIG. 3 depicts another side view of the aerosol-generating system according to embodiment 1 also including the various biasing elements;

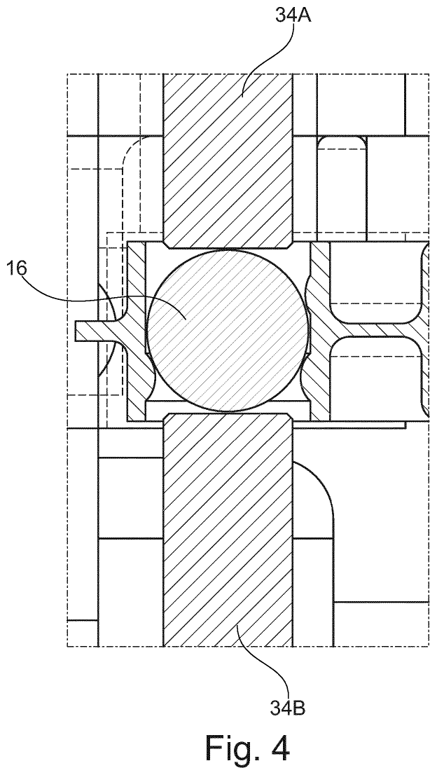

FIG. 4 shows a top view of a pushing element with beads for an aerosol-generating device according to embodiment 1;

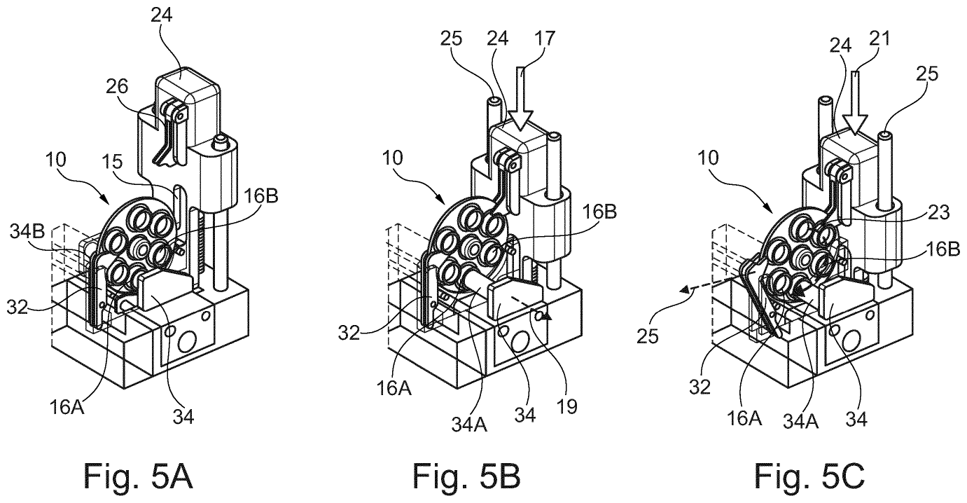

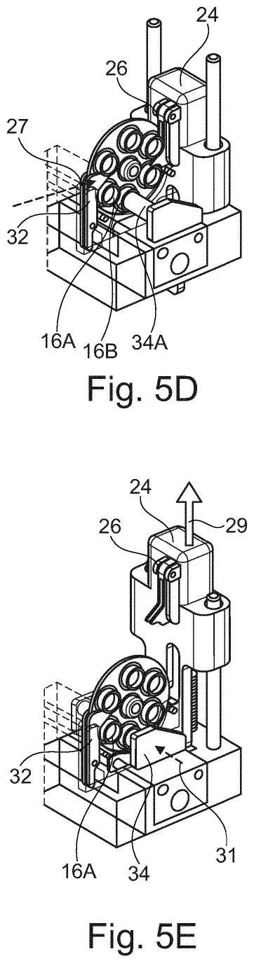

FIG. 5A to 5D show the sequence of different steps of an aerosol-generating system according to embodiment 1 with different loading steps for the beads;

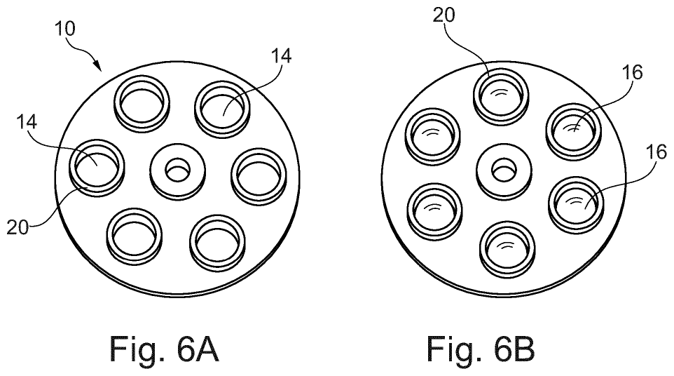

FIG. 6A to 6B depict photographs of further embodiments of cartridges according to embodiment 1;

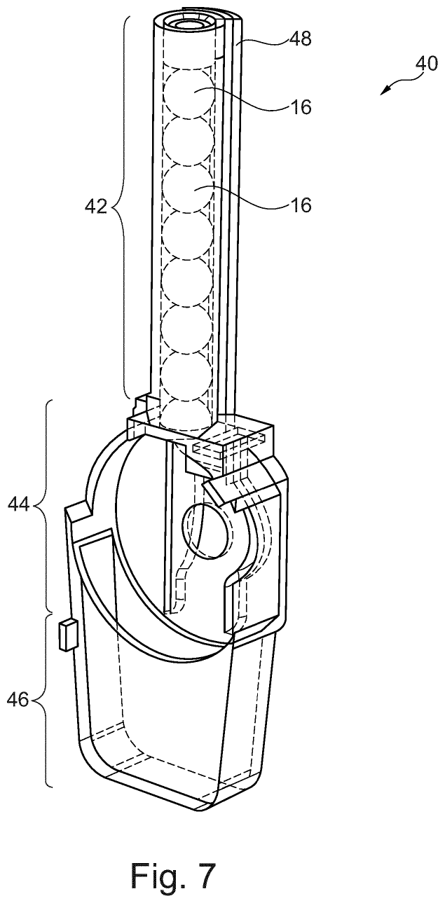

FIG. 7 depicts a perspective view of a cartridge according to embodiment 2 including a storage element;

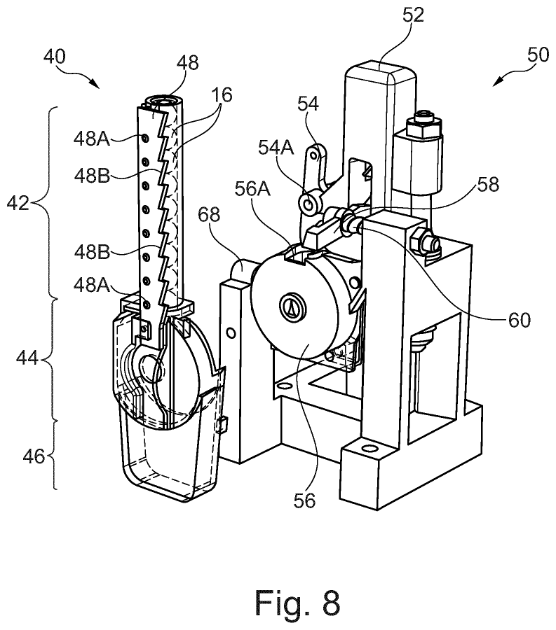

FIG. 8 depicts a perspective view of an aerosol-generating system with a separate cartridge and separate aerosol-generating device according to embodiment 2;

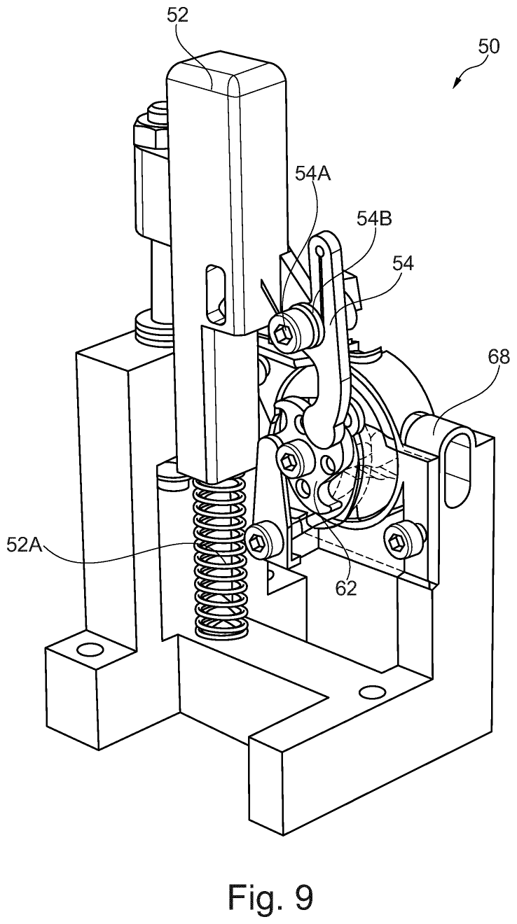

FIG. 9 shows a perspective view of the backside of the device according to embodiment 2 shown in FIG. 8;

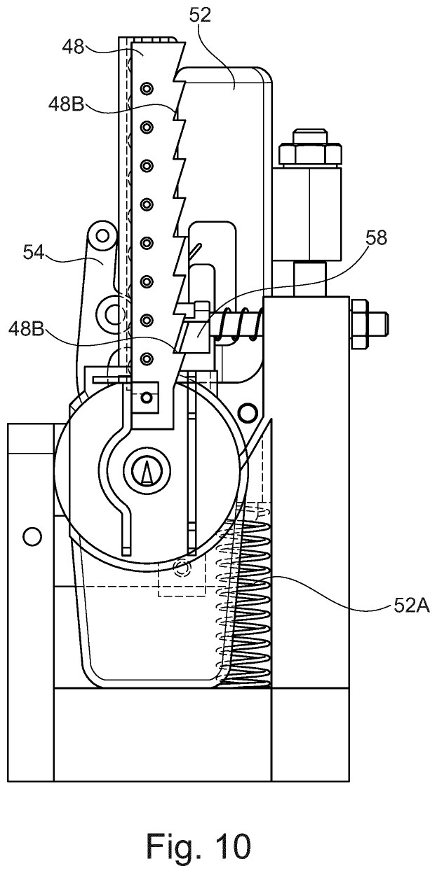

FIG. 10 shows a front view of the device of FIG. 9 showing the engagement of the rod with the second engagement element of the loading element;

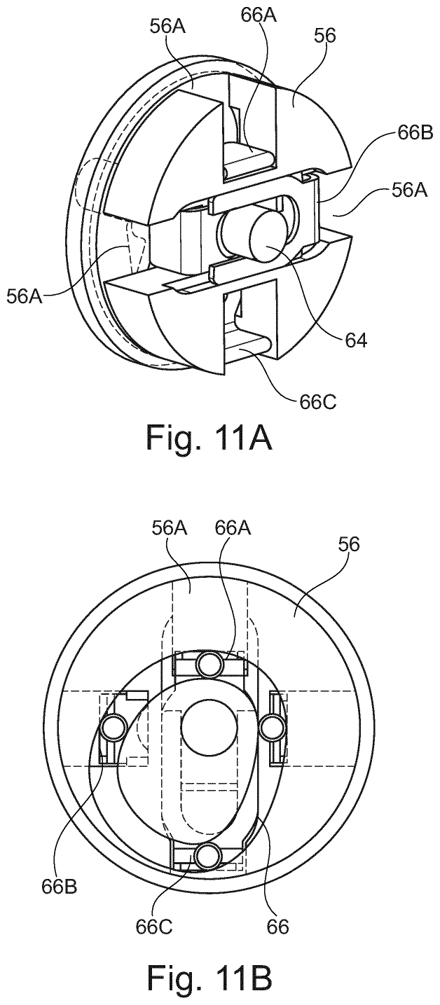

FIG. 11A and 11B show different views of the rotatably mounted conveyor of an aerosol-generating device according to embodiment 2;

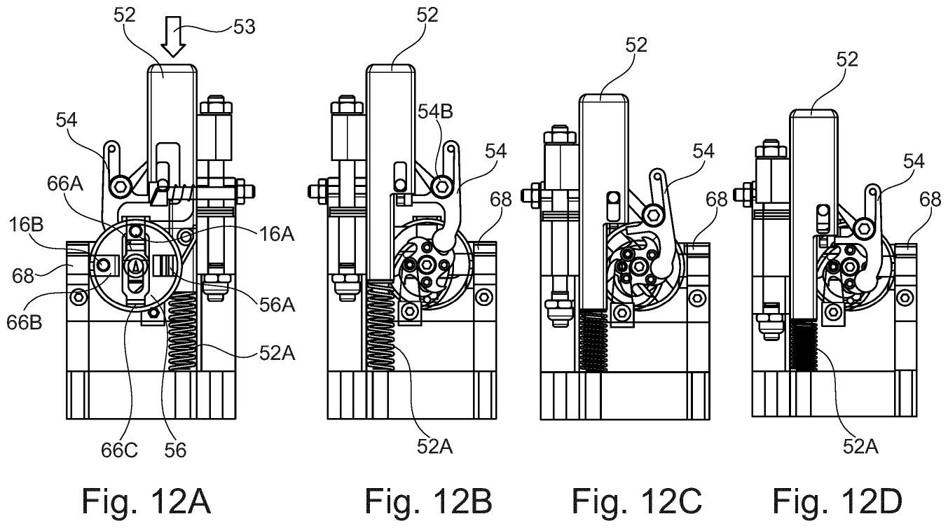

FIG. 12A to 12D show different positions and steps of loading a bead into the rotatable conveyor of the aerosol-generating device according to embodiment 2;

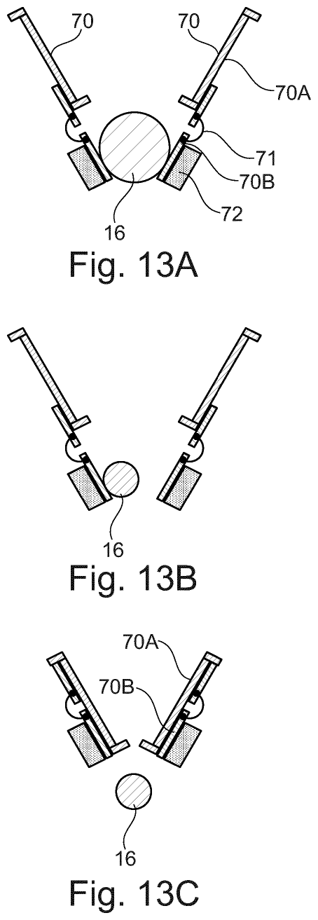

FIG. 13A to 13C show the opposing major surfaces of a heater system of an aerosol-generating device according to embodiment 3;

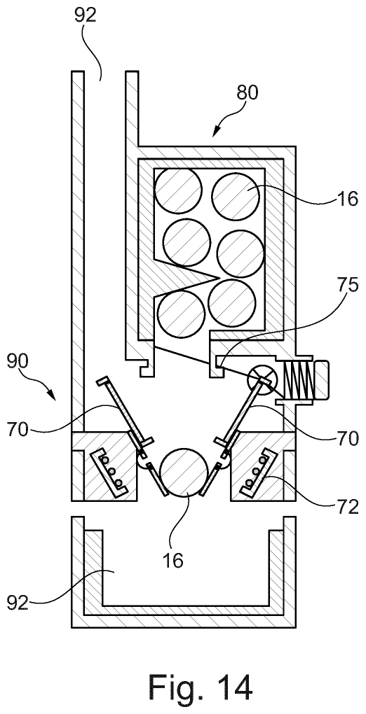

FIG. 14 depicts a schematic drawing of an aerosol-generating system according to embodiment 3; and

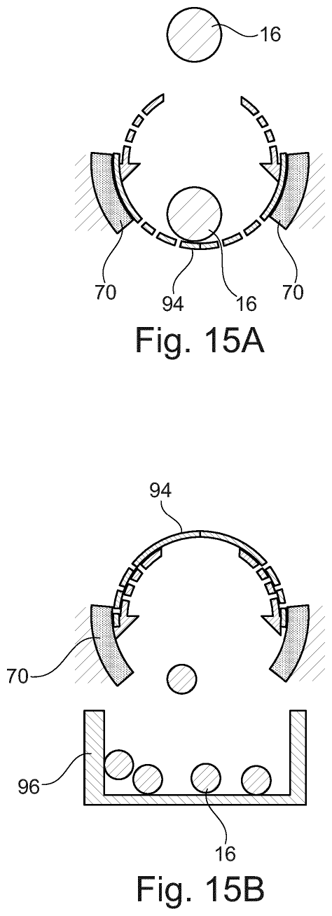

FIGS. 15A and 15B depict schematic drawings of a different aerosol-generating system according to embodiment 3.

In the following the same elements are marked with the same reference numerals throughout the figures.

FIG. 1 shows a side view of an aerosol-generating system according to embodiment 1. The aerosol-generating system includes an aerosol-generating device 22 and a cartridge 10. The cartridge 10 includes a storage element comprising a flat support element 12. Through holes 14 are present in the support element 12 which are arranged around the circumference of the disc-shaped support element. The through holes 14 include around their respective circumferences retention elements 20 for holding the aerosol-generating beads 16 in place. The cartridge 10 in FIG. 1 includes six through holes 14 with six beads 16. The aerosol-generating device 22 includes a first actuation element 24 with a push button and a first engaging arm 26 which is movably connected to the first actuation element 24 via the first engaging arm hinge 28. Additionally, a first flexible biasing member, for example a spring 30 is present. This first flexible biasing member 30 can be compressed and is able to return the first engaging arm 26 back into its original position. Additionally, a stopper 32 is present. This stopper 32 is able to control any rotational movement of the disc-like cartridge 10 triggered by pressing the first actuation element 24. This stopper 32 is also able to prevent a tilt of the disc-like cartridge 10 when pushed down by the first engaging arm. A pushing element 34 is also present in the aerosol-generating device 22. The pushing element enables the device 22 to remove beads 16 from the cartridge and convey these beads to the heating arrangement. Furthermore, the pushing element may also remove used beads from the heating arrangement (heating arrangement not shown in this figure). A user may press the first actuation element 24 which causes the first engaging arm to perform a translational downward movement towards cartridge 10. The first engaging arm will engage with the support element 12 and the retention elements 20 of the cartridge in order to trigger a rotational movement of the cartridge. The operational principle of such an aerosol-generating system will be explained in the following in more detail.

FIG. 2 depicts a side view of the aerosol-generating system shown in FIG. 1 rotated by 90 degrees. The first actuation element 24 is shown with the first engaging arm 26. This engaging arm includes a groove 26A which helps the first engaging arm to engage with the support element 12 and the retention elements 20 of the storage element. The retention elements 20 can consist of a ring of flexible protrusions surrounding the through holes of the support element. FIG. 2 shows that retention elements 20 are present on both opposing major surfaces of the support element 12 and are therefore able to hold the beads 16 within the through holes in place. FIG. 2 also shows the heating arrangement 38 positioned behind the cartridge. The first piston 34A of the pushing arrangement 34 extends through one through hole of the cartridge and has pushed a bead out of this through hole for positioning this bead in the heating arrangement 38 (bead in the heating arrangement not shown in this figure). The second piston 34B of the pushing element 34 which is located behind the heating arrangement 38 can also be seen. The second piston 34B is configured to push the bead located in the heating arrangement out of the heating arrangement back into its through hole in the cartridge after the bead has been heated. The side view also shows the stopper 32 with its respective stopper groove 32A. The stopper can engage with the cartridge, in particular with the support element 12 of the cartridge and the retention elements in order to stop a rotational movement of the cartridge triggered by the first engaging arm 26. The stopper can also help to prevent a tilt of support element 12 during its engagement with the first engaging arm 26 via the retention elements 20 on the opposite side as the stopper groove 32A keeps engaging with the support element. The stopper can ensure that rotational movement triggered by the first engaging arm 26 can be stopped after one through hole. This can ensure that successive beads in adjacent through holes of the cartridge can be brought in alignment with the pushing element to be pushed into the heating arrangement 38.

FIG. 3 shows another side view of the aerosol-generating system according to embodiment 1 which additionally shows the respective biasing elements present in the aerosol-generating device. The first actuation element 24 with the push button includes a first biasing member 24A, for example a spring. In FIG. 3 the first actuation element has been triggered by a user by pressing the push button, resulting in a compression of the first biasing member 24A. The first engaging arm 26 is also connected with an engaging arm biasing member 26A, for example a spring. This spring allows the first engaging arm 26 to be further pressed against the first actuation element and allows the first engaging arm to subsequently return to its original position. In FIG. 3 the first engaging arm is already in its lower position after having initiated a rotational movement of the cartridge. This rotational movement has been stopped after one through hole by the stopper 32 which is also flexibly connected to the device via the stopper biasing element 32A. The various biasing elements of the first actuation element 24, the stopper 32 and the first engaging arm 26 allow these elements to return to their original positions after being compressed.

FIG. 4 is a top view of a pushing element of an aerosol-generating device according to embodiment 1 with a bead 16 arranged between the first piston 34A and the second piston 34B. The pushing element 34 can push the bead accommodated in a through hole of the cartridge out of the through hole into the heating arrangement located behind the cartridge employing a forward movement of the first piston 34A which also simultaneously moves the second piston 34B into a position located behind the heating arrangement. After the bead in the heating arrangement has been used, a movement of the second piston and the first piston in the opposite direction with regard to the forward movement transports the used bead out of the heating arrangement back into its through hole in the cartridge.

FIGS. 5A to 5E show a sequence of successive steps through which an aerosol-generating system according to embodiment 1 passes after a user triggers the first actuation element 24 by pressing. FIG. 5A shows the situation before a user triggers the first actuation element. An old used bead 16A is located in the heating arrangement and the pushing element 34 is positioned so that the first piston 34A passes through the through hole which used to hold the old bead 16A (heating arrangement and first piston not shown in this figure). The second piston is located behind the heating arrangement so that it can push the old bead out of the heating arrangement. A guiding groove 15 of the first actuation element can be seen. A shank of the pushing element is movably connected to the guiding groove 15 so that a downward movement of the first actuation element can trigger pushing element 34.

When a user presses the push button of the first actuation element 24 a downward movement of the actuation element as indicated by the arrow 17 takes place as shown in FIG. 5B. This triggers a movement of the pushing element 34 wherein the second piston 34B transports the old used bead out of the heating arrangement and back into its through hole in the cartridge 10 as shown by the dashed arrow 19. FIG. 5B shows the first piston 34A which is now located in front of the cartridge 10. The first engaging arm 26 engages with the support element and the retention elements of one of the through holes of the cartridge 10 in order to initiate a rotational movement of the cartridge. The downward movement of the first actuation element 24 is guided by guard rails 25.

FIG. 5C shows the situation when a further downward movement of the first actuation element 24 shown by the arrow 21 triggers a rotational movement of the cartridge as indicated by the dashed arrow 23. This rotational movement moves the old bead 16A away from the pushing element and positions the new bead 16B in front of the pushing element. The stopper biasing element allows the stopper 32 to be moved out of its former position to enable the movement as indicated by the dashed arrow 25. The position shown in FIG. 5C shows the end of the forward movement of the first actuation element 24 triggered by a user's push.

Subsequently, the stopper arrests in the next position in order to stop the rotational movement of the cartridge as shown by the dashed arrow 27 in FIG. 5D. The backward movement of the first actuation element 24 as indicated by the arrow 29 in FIG. 5E is triggered by the compressed spring of the first actuation element. This backward movement leads to the pushing element 34 pushing the new bead 16B out of its through hole into the heating arrangement by employing the first piston 34A as indicated by the dashed arrow 31. The movement of the pushing element 34 is triggered by the guiding groove 15 of the first actuation element. The new bead 16B in the heating arrangement can now be heated in order to generate aerosol for inhalation by a user.

FIG. 6A shows a top photograph of a further embodiment of a cartridge according to embodiment 1. The cartridge 10 includes multiple through holes 14 which are arranged around a circumference of the disc-shaped support element. The circumferences of the through holes 14 are surrounded by a retention element 20 in the form of flexible lips, made for example of rubber. These retention elements 20 can hold beads 16 located in the through holes in place as shown in FIG. 6B.

FIG. 7 depicts a perspective view of a cartridge according to embodiment 2 of the present invention. The cartridge 40 includes a storage element 42 which includes beads 16 arranged in a row. On the opposite side of the storage element 42 a loading element 48 in the form of an elongated bar is present. A connection element 44 which is configured to be detachably connectable to a rotatably mounted conveyor of the aerosol-generating device is present in the central part of the cartridge 40. The hollow circular body of the connection element 44 is connected to both the storage element 42 and the waste storage element 46 which stores used beads.

FIG. 8 shows a perspective view of an aerosol-generating system including the cartridge 40 and the aerosol-generating device 50 according to embodiment 2.

The cartridge 40 includes the storage element 42 and the connection element 44 which is connected to both the storage element 42 and the waste storage element 46. A loading element 48, an elongated bar is movably connected to the storage element 42 for example via a rail present in the storage element (rail behind the loading element not shown in FIG. 8). This loading element 48 includes protrusions 48A which may extend into the interior of the storage element 42. If the protrusions extend into the interior of the storage element, they may separate the beads 16 from each other. Portions of the protrusion extending into the interior of the storage element may comprise a shape corresponding to a curvature of the spheric beads. It is also possible that the protrusions 48A may not extend into the interior of the storage element. Furthermore, second engagement elements 48B of the loading element 48 are present which are configured to interact with a second actuation element 52 of the aerosol-generating device. These second engagement elements 48B can be in the form of saw teeth which can interact with a rod 58 of the aerosol-generating device 50. The cartridge 40 can be connected to the aerosol-generating device 50 by placing the rotatably mounted conveyor 56 in the connection element 44 of the cartridge. The aerosol-generating device 50 may then be detachably connected to the cartridge 40 via clips. An incremental movement of the loading element 48 will then be able to release one bead into a recess 56A of the rotatably mounted conveyor 56 housed in the connection element. The aerosol-generating device 50 includes a second actuation element 52 which can be pressed and which is movably connected to a second engaging arm 54 via a second engaging arm hinge 54A. This second engaging arm 54 can incrementally trigger a rotational movement of the rotatably mounted conveyor 56. This incremental rotation of the rotatably mounted conveyor can transport one bead located in the recess 56A near to or adjacent to the heating arrangement 68 of the device. The second actuation element 52 furthermore includes a rod 58 which is configured to interact with the second engagement element 48B of the loading element 48 and a spring bold 60 for actuating the rod.

FIG. 9 is a perspective view of the backside of the device according to embodiment 2 shown in FIG. 8. the second flexible biasing member 52A of the second actuation element 52 can be seen. This biasing member, for example a spring can easily be compressed when a user triggers the second actuation element via pushing. This second flexible biasing member triggers a backward movement of the second actuation element which will be explained in greater detail further below. The second engaging arm of 54 also includes a second engaging arm biasing element 54B, for example a flexible clip which allows the second engaging arm 54 to return to its original position after being triggered by pushing the second actuation element 52. The backside of the rotatably mounted conveyor 56 can be seen, in particular the conveyor engaging element 62. This conveyor engaging element 62 can be configured to engage with the second engaging arm 54 and can for example be a gear wheel. This gear wheel allows the second engaging arm 54 to incrementally rotate the rotatable conveyor. The rotatable conveyor is also able to transport a bead to the heating arrangement 68 shown in FIG. 9.

FIG. 10 is a front view of the device shown in FIG. 9. This figure clearly shows the engagement between the rod 58 of the second engagement element 52 and the saw teeth 48B of the bar of the loading element 48.

FIG. 11A is a perspective view of the back part of the rotatably mounted conveyor 56. The rotatably mounted conveyor 56 includes a spindle 64 which allows the conveyor to be rotated. The conveyor also includes four recesses 56A which are configured to receive a bead. Behind the rotatably mounted conveyor 56 a fixedly mounted eccentric frame 66 with mounted clips is present. One mounted clip position 66A creates a large space in the recess 56A for a bead to be received from the storage portion of the cartridge. A second clip position 66B spaces the bead further away from the centre of the rotatably mounted conveyor 56 in the direction of the outer periphery of the conveyor. In this recess the bead will be adjacent to the heating arrangement of the aerosol-generating device. A third clip position 66C does not leave any space for the bead. In this position any bead received in the recess 56A will be ejected from the rotatably mounted conveyor 56. This corresponds to the position of the recess 56A wherein a used bead is ejected into the waste storage element 46 of the cartridge. Therefore, the mounted clips of the fixedly mounted eccentric frame 66 shown in FIG. 11B result in recesses 56A of different size depending on the position of the recess in the aerosol-generating device.

FIGS. 12A to 12D show a sequence of successive steps through which an aerosol-generating system according to embodiment 2 passes after a user triggers the second actuation element 52 by pressing.

FIG. 12A shows a front view of the device depicting the four clips 66A, 66B and 66C of the fixedly mounted eccentric frame 66 of the rotatably mounted conveyor. It can be seen that the space in the recesses of the rotatably mounted conveyor is the largest in the upper position of the recess where a bead 16A is received from the storage element of the cartridge. This is due to the presence of the clip 66A. In contrast to that the clip 66C in the lower position does not leave any space in the recess for the bead so that it can easily be ejected into the waste storage element of the cartridge. Furthermore, a bead 16B is present in the recess with the mounted clip 66B. This bead 16B is adjacent to the heating arrangement 68 and can produce an aerosol by heating. If a user wants to replace the bead 16B with the new bead 16A, the user pushes the second actuation element 52 as indicated by the arrow 53. Pushing the second actuation element 52 leads to an engagement of the second engaging arm 54 with the conveyor engaging element 62 of the rotatable conveyor and causes a 90 degree rotation of the rotatable conveyor as shown in the backside view of FIG. 12B. This 90 degrees rotation causes the bead 16A to be placed adjacent to the heating arrangement 68 and the old bead 16B to be discarded in the waste storage element of the cartridge. FIGS. 12B to 12D show different stages of this 90 degrees rotation and also evidence that the second flexible biasing member 52A is successively more compressed when the second actuation element 52 is pushed further down. Releasing the tension of the second flexible biasing member 52A leads to a backward movement of the second actuation element 52 so that the rod 58 engages with the saw teeth of the loading element, releasing one additional bead into the recess of the rotatably mounted conveyor. During the stroke of the second actuation element 52, the rod 58 releases from the saw teeth 48B and moves above it. During release of the second actuation element 52, the rod 58 cannot move below the saw teeth 48B, but pushes down the saw teeth 48B to return to the initial position, and while doing so, pushes the loading element 48 down to convey the leading bead into recess 56A.

FIGS. 13A to 13C depict schematic drawings of converging conduct included in an aerosol-generating device according to embodiment 3. FIG. 13A shows that a bead 16 is received in a converging conduct including two opposing major surfaces 70, for example plates. The area with the minimum distance between both opposing major surfaces can reliably hold the bead 16 and heating arrangements 72 can subsequently heat the bead in order to generate an aerosol. Bead 16 will shrink while being heated until a diameter of the bead 16 is smaller than the minimum distance between both opposing major surfaces and the bead will successively fall through the hole between both surfaces, preferably into a waste storage element as shown in FIG. 13B. The opposing major surfaces also include a flexible hinge 71. These flexible hinges may allow a user to prematurely release a bead by triggering the hinges. One major surface can include an upper portion 70A and a lower portion 70B which are slidably connected. Therefore, the lower part of the opposing major surfaces may be slidably retracted as shown in FIG. 13C in order to release the bead.

FIG. 14 depicts a schematic drawing of an aerosol-generating system according to embodiment 3. This aerosol-generating system includes a cartridge 80, and an aerosol-generating device 90 including a mouthpiece 92. The cartridge 80 includes a dispenser system 75 which allows one bead 16 to be ejected into the aerosol-generating device 90. This bead 16 will be received in the area with the minimum distance between both opposing plates 70 and will be heated by an inductive heating system 72. After the bead 16 has shrunk due to heating, it can fall through the gap between both opposing plates 70 and can be received in the waste storage section 92 of the device.

FIGS. 15A and 15B show schematic cross-sectional views of another aerosol-generating device including retractable plates in order to receive a bead 16. The retractable plates can have the form of two separate parts which form a half sphere receiving the bead 16 from the cartridge. This half sphere is connected to heaters 70 which are able to heat the bead received in the half sphere. The material of the half sphere can be material able to conduct heat, such as a metal. After the bead has been used the two parts of the half sphere can be retracted, thereby releasing the used beads into the waste storage element 96 as shown in FIG. 15B.

1. A cartridge for an aerosol-generating device, the cartridge comprising:
aerosol-generating beads comprising an aerosol-forming substrate,
a storage element configured to store the aerosol-generating beads,
wherein the storage element is configured to allow loading of the aerosol-generating beads from the storage element, wherein the storage element comprises a support element, the support element comprising through holes, wherein the through holes are configured to accommodate the beads.

2. The cartridge according to claim 1, wherein the storage element is configured to allow loading of one single bead from the storage element by one loading step.

3. The cartridge according to claim 1, wherein one through hole is configured to accommodate one bead.

4. The cartridge according to claim 1, wherein the cartridge is configured to be detachably rotatably connectable to an aerosol-generating device.

5. A cartridge for an aerosol-generating device, the cartridge comprising:
aerosol-generating beads comprising an aerosol-forming substrate,
a storage element configured to store the aerosol-generating beads,
wherein the storage element is configured to allow loading of the aerosol-generating beads from the storage element, further comprising a connection element, the connection element being configured to be detachably connectable to an aerosol-generating device, wherein the storage element is configured to allow loading of the aerosol-generating beads into the connection element.

6. The cartridge according to claim 5, further comprising a loading element configured for loading the beads from the storage element to the connection element, wherein the loading element is movably connected with the storage element preferably, wherein the loading element is incrementally movably connected with the storage element and wherein a single incremental movement is configured to load one bead into the connection element.

7. The cartridge according to claim 6, wherein the loading element comprises a second engagement element, wherein the second engagement element is configured to be engaged with a second actuation element of the aerosol-generating device, preferably wherein the second engagement element comprises saw teeth.

8. An aerosol-generating device comprising:
a receiving region configured to receive a cartridge according to claim 1,
a heating arrangement configured to heat the aerosol-generating beads,
a loading element configured to load the aerosol-generating beads from the cartridge into or adjacent to the heating arrangement.

9. The aerosol-generating device according to claim 8, wherein the loading element is configured to load one single bead from the cartridge at a time.

10. The aerosol-generating device according to claim 8, further comprising a pushing element configured for pushing beads accommodated in the through holes into the heating arrangement, preferably wherein the pushing element is further configured to push used beads out of the heating arrangement.

11. The aerosol-generating device according to claim 10, furthermore comprising a first actuation element, wherein the first actuation element is configured to actuate the pushing element, wherein the pushing element comprises a shank and wherein the first actuation element comprises a guiding groove for actuating the pushing element.

12. The aerosol-generating device according to claim 8, wherein the receiving region comprises a rotatably mounted conveyor, wherein the conveyor is configured to be connectable to the connection region of the cartridge according to claim 5.

13. The aerosol-generating device according to claim 12, furthermore comprising a second actuation element wherein the second actuation element is configured to actuate the rotatably mounted conveyor.

14. An aerosol-generating system comprising a cartridge according to claim 1 and an aerosol-generating device according to claim 8.

15. An aerosol-generating system comprising a cartridge according to claim 5 and an aerosol-generating device according to claim 12.

16. The aerosol-generating device according to claim 10, furthermore comprising a first actuation element, wherein the first actuation element is configured to actuate the pushing element, wherein the pushing element comprises a shank and wherein the first actuation element comprises a guiding groove for actuating the pushing element, and the first actuation element is also configured to subject the cartridge to a movement.

17. The aerosol-generating device according to claim 10, furthermore comprising a first actuation element, wherein the first actuation element is configured to actuate the pushing element, wherein the pushing element comprises a shank and wherein the first actuation element comprises a guiding groove for actuating the pushing element, and the first actuation element is also configured to subject the cartridge to a movement, and the movement is an incremental rotational movement between adjacent through holes of the cartridge.
